(19) United States
(12) Patent Application Publication
(10) Pub. No.: US 2004/0010079 A1
(43) Pub. Date: Jan. 15, 2004

(54) Latices for paper coatings based on halogen-and sulfur-free molecular weight regulators

(75) Inventor: Uwe Schulze, Meerbusch (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: POLYMERLATEX GmbH & Co. KG, Marl (DE)

(21) Appl. No.: 10/612,071

(22) Filed: Jul. 3, 2003

(30) Foreign Application Priority Data
Jul. 8, 2002 (DE) 102 30 793.8

(51) Int. Cl. C08L 33/00

(52) U.S. Cl. 524/819

(57) ABSTRACT

A polymer latex prepared in the presence of a halogen-free and sulfur-free chain transfer agent can be used for paper coating applications, in particular in the area of odor-sensitive applications, such as food packaging. The polymer latex contains in polymerized form: a) from 10% to 80% by weight of one or more monovinylaromatic monomers; b) from 0% to 70% by weight of one or more conjugated diene monomers; c) from 0% to 70% by weight of one or more acrylate monomers; and d) a remainder of one or more other copolymerizable comonomers, with the condition that a sum of the percentages by weight of components b) and c) is greater than zero.

### BACKGROUND OF THE INVENTION

1. Field of the Invention

The present invention relates to polymer latices which were prepared using halogen-free and sulfur-free molecular weight regulators, and which can be used, for example, for paper coating applications.

2. Discussion of the Background

Latices which can be used for coating paper and cardboard must have good binding properties (i.e. pick resistance). Therefore, the molecular weight of the polymer latices need to be controlled by regulators during the polymerization. In the past, halogen-containing compounds (e.g. carbon tetrachloride) were used for this purpose. For ecological reasons, however, these regulators were “banned” from the polymer latices a few years ago and replaced by sulfur-containing regulators. The most well known group of these regulators are the mercaptans, whose most prominent member in turn is tert-dodecyl mercaptan (t-DDM).

Mercaptans meet the requirements very well with respect to the regulator effect in polymer latices, i.e. latices which have very good dry and wet pick resistances are obtained when using mercaptans. The major disadvantages of latices which have been prepared with the aid of mercaptans is, however, that they lead to undesired odor annoyances in certain applications in paper coating. This is a decisive disadvantage in particular in the area of packaging papers and packaging cardboards. Polymer latices which are used for these odor-sensitive applications therefore must not contain any sulfur-containing regulators.

U.S. Pat No. 5,837,762 describes the use of rosin-containing chain transfer agents for the preparation of polymer latices. The latices thus synthesized have the disadvantage that the regulator efficiency of rosin is very low in contrast to mercaptans. Thus, up to 9 pph of rosin have to be used in the polymerization of the latex in order to obtain acceptable values for the dry pick resistance in coated paper. In addition, rosin is a natural product which, depending on the source, is subject to certain quality variations. Finally, a third disadvantage which should be mentioned is that rosin has a strong natural color (yellow to brown) which may also lead to quality disadvantages in coated paper.

Outside the area of aqueous polymer dispersions (latices), the patent literature cites various peroxides which are said to have a regulating effect. Thus, for example, WO 9630415 A1 describes the use of alkoxyallyl (di)peroxides as molecular weight regulators in the free radical polymerization of styrene, methyl methacrylate and butyl acrylate. JP 63179902 A2 reports on the use of cumyl hydroperoxide as a molecular weight regulator in the free radical polymerization of unsaturated monomers, such as, for example, styrene.

### SUMMARY OF THE INVENTION

It is an object of the present invention to provide alternative regulator systems which are neither halogen-containing nor sulfur-containing, and which are nevertheless suitable for the preparation of polymer latices having sufficient binding power (i.e. pick resistance) and which can be used in the area of odor-sensitive applications for the coating of paper and cardboard.

This and other objects have been achieved by the present invention the first embodiment of which includes a polymer latex, prepared using a sulfur-free and halogen-free chain transfer agent and comprising, in polymerized form:

a) from 10% to 80% by weight of one or more monovinylaromatic monomers;

b) from 0% to 70% by weight of one or more conjugated diene monomers;

c) from 0% to 70% by weight of one or more acrylate monomers; and

d) a remainder of one or more other copolymerizable comonomers, with the condition that a sum of the percentages by weight of components b) and c) is greater than zero,

wherein said chain transfer agent is at least one peroxide selected from the group consisting of compounds of formulae A) to F)

A) hydroperoxides of the formula

R—O—O—H

wherein R is H or one of the following radicals:

linear or branched C₁-C₁₆ alkyl,

linear or branched C₁-C₁₆ alkyl in combination with C₁-C₁₈ aryl, or C₁-C₁₈ aryl;

B) peroxides of the formula

R₁—O—O—R₂

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl;

C) peroxides of the formula

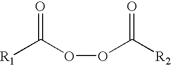

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl;

D) peroxocarboxylic acids of the formula

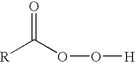

wherein

R is H or one of the following radicals:

linear or branched C₁-C₁₆ alkyl,

linear or branched C₁-C₁₆ alkyl in combination with C₁-C₁₈ aryl, or C₁-C₁₈ aryl;

E) peroxocarboxylic esters of the formula

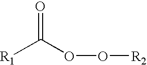

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl; and

F) peroxodicarbonates of the formula

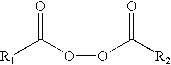

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl; and

wherein said polymer latex has a glass transition temperature of from −30° C. to 70° C.

In another embodiment the present invention relates to a process for the preparation of a polymer latex, comprising:

reacting

a) from 10% to 80% by weight of one or more monovinylaromatic monomers;

b) from 0% to 70% by weight of one or more conjugated diene monomers;

c) from 0% to 70% by weight of one or more acrylate monomers; and

d) a remainder of one or more other copolymerizable comonomers, with the condition that a sum of the percentages by weight of components b) and c) is greater than zero, in the presence of a sulfur-free and halogen-free chain transfer agent, to obtain a polymer latex having a glass transition temperature of from −30 to 70° C.;

wherein said chain transfer agent is at least one peroxide selected from the group consisting of compounds of formulae A) to F)

A) hydroperoxides of the formula

R—O—O—H

wherein R is H or one of the following radicals:

linear or branched C₁-C₁₆ alkyl,

linear or branched C₁-C₁₆ alkyl in combination with C₁-C₁₈ aryl, or C₁-C₁₈ aryl;

B) peroxides of the formula

R₁—O—O—R₂

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl;

C) peroxides of the formula

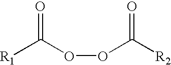

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl;

D) peroxocarboxylic acids of the formula

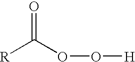

wherein R is H or one of the following radicals:

linear or branched C₁-C₁₆ alkyl,

linear or branched C₁-C₁₆ alkyl in combination with C₁-C₁₈ aryl, or C₁-C₁₈ aryl;

E) peroxocarboxylic esters of the formula

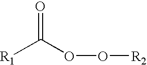

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl; and

F) peroxodicarbonates of the formula

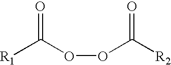

wherein R₁ and R₂ are identical or different and are one of the following radicals:

linear or branched C₁-C₁₆ alkyl,

linear or branched C₁-C₁₆ alkyl in combination with C₁-C₁₈ aryl, or C₁-C₁₈ aryl.

### DETAILED DESCRIPTION OF THE INVENTION

The present invention relates to a polymer latex for use in the coating of paper and cardboard. The polymer latex has a glass transition temperature of from −30° C. to 70° C. The latex is prepared using a sulfur- and halogen-free chain transfer agent and comprises, in polymerized form:

a) from 10 to 80% by weight of one or more monovinylaromatic monomers;

b) from 0 to 70% by weight of one or more conjugated diene monomers;

c) from 0 to 70% by weight of one or more acrylate monomers; and

d) a remainder of one or more other copolymerizable comonomers, with the condition that the sum of the percentages by weight of components b) and c) is greater than zero, wherein the chain transfer agent is a peroxide selected from at least one member of the following formulae A) to F):

A) Hydroperoxides of the general structural formula

R—O—O—H

in which R is H or one of the following radicals:

C₁-C₁₆ alkyl (linear or branched),

C₁-C₁₆ alkyl (linear or branched) in combination with C₁-C₁₈ aryl, or C₁-C₁₈ aryl;

B) Peroxides of the general structural formula

R₁—O—O—R₂

in which R₁ and R₂ are identical or different and are one of the following radicals:

C₁-C₁₆ alkyl (linear or branched),

C₁-C₁₆ alkyl (linear or branched) in combination with C₁-C₁₈ aryl, or C₁-C₁₈ aryl;

C) Peroxides of the general structural formula

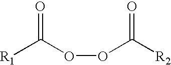

in which R₁ and R₂ are identical or different and are one of the following radicals:

C₁-C₁₆ alkyl (linear or branched),

C₁-C₁₆ alkyl (linear or branched) in combination with C₁-C₁₈ aryl, or C₁-C₁₈ aryl;

D) Peroxocarboxylic acids of the general structural formula

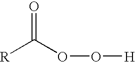

in which R is H or one of the following radicals:

C₁-C₁₆ alkyl (linear or branched),

C₁-C₁₆ alkyl (linear or branched) in combination with C₁-C₁₈ aryl, or C₁-C₁₈ aryl;

E) Peroxocarboxylic esters of the general structural formula

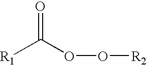

in which R₁ and R₂ are identical or different and are one of the following radicals:

C₁-C₁₆ alkyl (linear or branched),

C₁-C₁₆ alkyl (linear or branched) in combination with C₁-C₁₈ aryl, or C₁-C₁₈ aryl; and

F) Peroxodicarbonates of the general structural formula

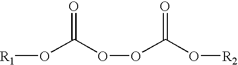

in which R₁ and R₂ are identical or different and are one of the following radicals:

C₁-C₁₆ alkyl (linear or branched),

C₁-C₁₆ alkyl (linear or branched) in combination with C₁-C₁₈ aryl, or C₁-C₁₈ aryl.

The amount of monovinylaromatic monomers in the latex includes all values and subvalues therebetween, especially including 15, 20, 25, 30, 35, 40, 45, 50, 55, 60, 65, 70 and 75% by weight. The amount of conjugated diene monomers includes all values and subvalues therebetween, especially including 5, 10, 15, 20, 25, 30, 35, 40, 45, 50, 55, 60 and 65% by weight. The amount of acrylate monomers includes all values and subvalues therebetween, especially including 5, 10, 15, 20, 25, 30, 35, 40, 45, 50, 55, 60 and 65% by weight.

The present invention further relates to a process for the preparation of the above polymer latex.

The present invention also relates to the use of a polymer latex, prepared using a peroxide as a chain transfer agent, for coating paper and cardboard and the use of peroxides for the preparation of a polymer latex.

Preferred peroxides are the abovementioned compounds according to the structural formulae A)-F), but in particular the hydroperoxides A).

Tert-butyl hydroperoxide and cumyl hydroperoxide are particularly preferred. Furthermore, di-tert-butyl peroxide, tert-butyl peroxybenzoate and tert-butyl peroxy-3,5,5-trimethylhexanoate are preferably used.

Typical amounts of peroxides used are in the range of from 0.1-10% by weight, preferably of from 0.5-5% by weight, particularly preferably of from 0.5 to 3% by weight, based on 100% by weight of monomer. The amount of peroxide includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5% by weight, based on 100% by weight of monomers. The above amount of peroxides makes it possible to achieve a crosslinking density in the polymer which is analogous to that obtained with sulfur-containing regulators (measurable, for example, by determination of the gel content of the polymer). The obtained polymer latices have very good properties, such as, for example, pick resistance in the paper coat, which are comparable with those of polymer latices regulated by mercaptan. However, the peroxides used, in particular tert-butyl hydroperoxide and cumyl hydroperoxide, are not suitable, under the conditions described, for acting as an initiator in the polymerization. A separate initiator system, such as, for example, ammonium persulfate or sodium persulfate, is required for this purpose. Without the addition of an initiator, the polymerization would not function, which can serve as evidence that the peroxides used, in particular the tert-butyl hydroperoxide and cumyl hydroperoxide, do not act as an initiator but as a molecular weight regulator under the polymerization conditions. Therefore, only peroxides which exhibit no thermal decomposition or only very little thermal decomposition at the present polymerization temperatures are suitable for use as regulators in the context of the present invention. Moreover, it must be ensured that no strong reducing agent which might initiate spontaneous decomposition of the peroxide (i.e. redox initiator system) is present in the system.

Representative monovinylidene-aromatic monomers include, for example: styrene, α-methylstyrene, p-methylstyrene, tert-butylstyrene and vinyltoluene. Mixtures of one or more monovinylidene-aromatic monomers may also be used. The preferred monomers are styrene and α-methylstyrene. The monovinylidene-aromatic monomer is generally used in a range of from 10 to 80% by weight, preferably of from 25 to 75% by weight, most preferably of from 35 to 70% by weight, based on the total weight of the monomers. The amount of monovinylidene-aromatic monomer includes all values and subvalues therebetween, especially including 15, 20, 25, 30, 35, 40, 45, 50, 55, 60, 65, 70 and 75% by weight based on the total weight of monomers.

Conjugated diene monomers suitable for the preparation of the latices include conjugated diene monomers, such as, for example, 1,3-butadiene, isoprene and 2,3-dimethyl-1,3-butadiene. 1,3-Butadiene is preferred in the present invention. Typically, the amount of conjugated diene monomer (if used) which is present in the polymeric phase ranges of from 0 to 70% by weight, preferably of from 20 to 65% by weight, more preferably of from 20 to 55% by weight, even more preferably of from 30 to 50% by weight, most preferably of from 30 to 45% by weight, based on the total weight of the monomers. The amount of conjugated diene includes all values and subvalues therebetween, especially including 5, 10, 15, 20, 25, 30, 35, 40, 45, 50, 55, 60 and 65% by weight, based on the total weight of monomers.

Acrylate monomers which can be used in the present invention include, for example: n-alkyl esters, iso-alkyl esters or tert-alkyl esters of acrylic or methacrylic acid, in which the alkyl group has from 1 to 20 carbon atoms, the reaction product of (meth)acrylic acid with the glycidyl ester of a neo acid, such as versatic acids, neodecanoic acids or pivalic acid. In addition, the acrylate monomers may include acids, esters, amides of (meth)acrylic acid and substituted derivatives thereof.

In general, the preferred acrylate monomers are C₁-C₁₀-alkyl (meth)acrylates or alkoxy-C₁-C₁₀-alkyl (meth)acrylates, most preferably C₁-C₈-alkyl (meth)acrylates or alkoxy-C₁-C₈-alkyl (meth)acrylates. Examples of such acrylate monomers include n-butyl acrylate, sec-butyl acrylate, ethyl acrylate, hexyl acrylate, tert-butyl acrylate, 2-ethylhexyl acrylate, isooctyl acrylate, 4-methyl-2-pentyl acrylate, 2-methylbutyl acrylate, methyl methacrylate, butyl methacrylate, n-butyl methacrylate, isobutyl methacrylate, ethyl methacrylate, isopropyl methacrylate, hexyl methacrylate, cyclohexyl methacrylate and cetyl methacrylate, methoxyethyl methacrylate, ethoxyethyl acrylate, butoxyethyl methacrylate, methoxybutyl acrylate and methoxyethoxyethyl acrylate.

Preferred acrylate monomers are n-butyl acrylate, butyl methacrylate, 2-ethylhexyl acrylate and methyl methacrylate, methyl methacrylate and n-butyl acrylate being particularly preferred. Frequently, two or more acrylate monomers are used. The alkyl esters of acrylic or methacrylic acid and alkoxyalkyl (meth)acrylate monomers can be used as part of the monomer mixture.

Typically, the amount of acrylate monomers (if used) which are present in the polymeric phase depends on the monomer chosen, but the typical range is from 0 to 70% by weight, preferably from 0 to 60% by weight, most preferably from 0 to 51% by weight, based on the total weight of the monomers. The amount of acrylate monomers includes all values and subvalues therebetween, especially including 5, 10, 15, 20, 25, 30, 35, 40, 45, 50, 55, 60 and 65% by weight based on the total weight of the monomers.

It is critical that the combined percentage by weight of conjugated diene monomer or monomers (component B) and acrylate monomer or monomers (component C) is greater than zero, preferably greater than 10%.

As stated above, other polymerizable comonomers include, for example: ethylenically unsaturated carboxylic acid monomers, nitrile monomers, vinyl ester monomers, hydroxyalkyl (meth)acrylate monomers, alkoxyalkyl (meth)acrylate monomers and (meth)acrylamide monomers.

The ethylenically unsaturated carboxylic acid monomers suitable for use in the present invention include monocarboxylic acid and dicarboxylic acid monomers and the monoesters thereof. It has been found that the addition of such an ethylenically unsaturated carboxylic acid monomer greatly improves the stability of the latex and the adhesion of the latex film, with the result that they are suitable for use in formulations for the coating of paper. For carrying out the present invention in practice, it is preferable to use ethylenically unsaturated aliphatic mono- or dicarboxylic acid(s) or anhydride(s) which contain from 3 to 5 carbon atoms. Examples of monocarboxylic acid monomers include, for example, acrylic acid and methacrylic acid, and examples of dicarboxylic acid monomers include, for example, fumaric acid, itaconic acid, crotonic acid, maleic acid and maleic anhydride.

The use of ethylenically unsaturated carboxylic acid monomers influences the properties of the polymer dispersion and of the coating produced therefrom. The type and the amount of these monomers are determined thereby. Typically, such an amount is from 0 to 20% by weight, preferably from 0 to 10% by weight, most preferably from 1 to 10% by weight, based on the total weight of the monomers. The amount of ethylenically unsaturated carboxylic acid monomers includes all values and subvalues therebetween, especially including 2, 4, 6, 8, 10, 12, 14, 16 and 18% by weight based on the total weight of the monomers.

Nitrile monomers which can be used in this present invention include polymerizable unsaturated aliphatic nitrile monomers which contain from 2 to 4 carbon atoms in a linear or branched arrangement which may be substituted either by acetyl or additional nitrile groups. Such nitrile monomers include, for example, acrylonitrile, methacrylonitrile and fumaronitrile, with acrylonitrile being preferred. These nitrile monomers (if used) may be included in amounts of up to about 25 parts by weight, preferably from 0 to 15 parts by weight, based on 100 parts by weight of monomers. The amount of nitrile monomers includes all values and subvalues between 0 and 25 parts by weight, especially including 2, 4, 6, 8, 10, 12, 14, 16, 18, 20, 22 and 24 parts by weight based on 100 parts by weight of monomers.

Vinyl ester monomers which can be used here include vinyl acetate, vinyl propionate, vinyl butyrate, vinyl benzoate, vinyl 2-ethylhexanoate, vinyl stearate and the vinyl esters of versatic acid. The most preferred vinyl ester monomer for use in the present invention is vinyl acetate. Typically, the amount of vinyl ester monomer (if used) which is present in the polymeric phase ranges from 0 to 45% by weight, preferably from 0 to 35% by weight, based on the total weight of the monomers. The amount of vinyl ester monomer includes all values and subvalues therebetween, especially including 5, 10, 15, 20, 25, 30, 35 and 40% by weight.

The hydroxyalkyl (meth)acrylate monomers which can be used here include hydroxyalkyl acrylate and methacrylate monomers which are based on ethylene oxide, propylene oxide and other higher alkylene oxides or mixtures thereof Examples are hydroxyethyl acrylate, hydroxypropyl acrylate, hydroxyethyl methacrylate, hydroxypropyl methacrylate and hydroxybutyl acrylate. Preferred hydroxyalkyl (meth)acrylate monomers are hydroxyethyl acrylate, hydroxypropyl acrylate and hydroxybutyl acrylate. Typically, the amount of hydroxyalkyl (meth)acrylate monomers (if used) which is present in the polymeric phase depends on the monomer chosen, but the typical range is from 0 to 15% by weight, preferably from 0 to 10% by weight, most preferably from 1 to 10% by weight, based on the total weight of the monomers. The amount of hydroxyalkyl(meth)acrylate includes all values and subvalues therebetween, especially including 2, 4, 6, 8, 10, 12 and 14% by weight, based on the total weight of the monomers.

Alkoxyalkyl (meth)acrylate monomers which can be used in this present invention include methoxyethyl methacrylate, ethoxyethyl methacrylate, methoxyethyl acrylate, ethoxyethyl acrylate, butoxyethyl methacrylate, methoxybutyl acrylate and methoxyethoxyethyl acrylate. Preferred alkoxyalkyl (meth)acrylate monomers are ethoxyethyl acrylate and methoxyethyl acrylate. Typically, the amount of alkoxyethyl (meth)acrylate monomers (if used) which is present in the polymeric phase depends on the monomer chosen, but the typical range is from 0 to 65% by weight, preferably from 0 to 45% by weight, based on the total weight of the monomers. The amount of alkoxyalkyl(meth)acrylate monomers includes all values and subvalues therebetween, especially including 5, 10, 15, 20, 25, 30, 35, 40, 45, 50, 55 and 60% by weight, based on the total weight of the monomers.

(Meth)acrylamide monomers which can be used here include the amides of α, β-olefinically unsaturated carboxylic acids, such as, for example, acrylamide, methacrylamide and diacetoneacrylamide. The preferred (meth)acrylamide monomer is acrylamide. Typically, the amount of (meth)acrylamide monomers (if used) which is present in the polymeric phase depends on the monomer chosen, but the typical range is from 0 to 10% by weight, preferably from 0 to 5% by weight, most preferably from 0 to 2% by weight, based on the total weight of the monomers. The amount of (meth)acrylamide monomers includes all values and subvalues therebetween, especially including 2, 4, 6 and 8% by weight, based on the total weight of the monomers.

In one embodiment, the polymer latex composition of the present invention comprises styrene, butadiene, acrylic acid and a peroxide as a chain transfer agent.

In another embodiment, the polymer latex composition of the present invention comprises styrene, butadiene, acrylonitrile, acrylic acid and a peroxide as a chain transfer agent.

In general, the polymer latex composition of the present invention can be prepared by polymerization processes which are known in the technical area, and in particular by the known latex emulsion polymerization processes, including a latex polymerization carried out with seeds (seed latex) and a latex polymerization not carried out with seeds. Representative processes include those which are described in U.S. Pat No. 4,478,974; U.S. Pat. No. 4,751,111; U.S. Pat. No.4,968,740; U.S. Pat. No. 3,563,946; U.S. Pat. No. 3,575,913; and DE-A-19 05 256. Such processes can be adapted for the polymerization of the monomers described above. The method for introducing the monomers and other ingredients, such as polymerization assistants, is not particularly critical. The polymerization is then carried out under conventional conditions until the desired degree of polymerization has been reached. Crosslinking agents and the well known assistants for latex polymerization, such as initiators, surfactants and emulsifiers, can be used depending on requirements.

The present invention relates to a process for the preparation of the above-described polymer latex at temperatures of from 0 to 130° C., preferably of from 60 to 130° C., particularly preferably of from 60 to 100° C., very particularly preferably of from 75 to 100° C., in the presence of one or more emulsifiers and one or more initiators, such as, for example, preferably sodium persulfate or ammonium persulfate. The temperature includes all values and subvalues therebetween, especially including 5, 10, 15, 20, 25, 30, 35, 40, 45, 50, 55, 60, 65, 70, 75, 80, 85, 90, 95, 100, 105, 110, 115, 120 and 125° C.

Initiators which can be used when carrying out the present invention include water-soluble and/or oil-soluble initiators which are effective for the purposes of the polymerization. Representative initiators are well known in the technical area and include, for example: azo compounds (such as, for example, AIBN) and persulfates (such as, for example, potassium persulfate, sodium persulfate and ammonium persulfate).

The initiator is used in a sufficient amount to initiate the polymerization reaction at a desired rate. In general, an amount of initiator of from 0.05 to 5, preferably of from 0.1 to 4%, by weight, based on the weight of the total polymer, is sufficient. The amount of initiator is most preferably of from 0.1 to 3% by weight, based on the total weight of the polymer. The amount of initiator includes all values and subvalues therebetween, especially including 0.1, 0.5, 1, 1.5, 2, 2.5, 3, 3.5, 4and 4.5% by weight, based on the total weight of the polymer.

Surfactants or emulsifiers which are suitable for stabilizing the latex particles include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seed process, an effective amount of surfactant is the amount which was chosen for influencing the particle size.

Representative surfactants include saturated and ethylenically unsaturated sulfonic acids or salts thereof, including, for example, hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, ethoxylated alkylphenols and ethoxylated alcohols; fatty alcohol (poly)ethersulfates.

The type and the concentration of the surfactant depends typically on the content of polymer solids. A higher content of polymer solids generally increases the necessity for surfactant. Typically, the surfactant is used in amounts of from 0.05 to 20, preferably from 0.05 to 10, more preferably from 0.05 to 5, parts by weight, based on the total weight of the monomers. The amount of surfactant includes all values and subvalues therebetween, especially including 0.1, 0.5, 1, 2, 3, 4, 5, 6, 7, 8, 9, 10, 11, 12, 13, 14, 15, 16, 17, 18 and 19 parts by weight based on the total weight of the monomer.

Various protective colloids can also be used instead of or in addition to the surfactants described above. Suitable colloids include partially acetylated polyvinyl alcohol, casein, hydroxyethyl starch, carboxymethylcellulose, hydroxyethylcellulose, hydroxypropylcellulose and gum arabic. The preferred protective colloids are carboxymethylcellulose, hydroxyethylcellulose and hydroxypropylcellulose. In general, these protective colloids are used in contents of from 0 to 10, preferably from 0 to 5, more preferably from 0 to 2, parts by weight, based on the total weight of the monomers. The amount of protective colloids includes all values and subvalues therebetween, especially including 1, 2, 3, 4, 5, 6, 7, 8 and 9 parts by weight, based on the total weight of the monomers.

Various other additives and ingredients can be added in order to prepare the latex composition of the present invention. Such additives include, for example: antifoams, wetting agents, thickeners, plasticizers, fillers, pigments, crosslinking agents, antioxidants and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide, titanium dioxide, aluminum hydroxide, calcium carbonate and clay are the fillers typically used.

Having generally described this invention, a further understanding can be obtained by reference to certain specific examples which are provided herein for purposes of illustration only, and are not intended to be limiting unless otherwise specified.

Measuring Methods

Glass Transition Temperature:

The glass transition temperature was determined with the aid of a differential scanning calorimeter of the “Perkin-Elmer DSC 7” type. For this purpose, the polymer latex was dried in a Teflon mold at room temperature for three days and then for a further 20 hours at 65° C. The measurements were carried out in a temperature range of from −60° C. to 100° C. at a heating rate of 20 K/min. The glass transition temperature was specified as the point of inflection of the DSC curve.

Gel Content:

The insoluble fraction of a polymer in a specific solvent was determined with the aid of the gel content. In the present case, the measurement of the gel content served for determining the crosslinking of the polymer latex. The solvent used was toluene. The swelling was effected using films which were produced as described above. The gel insoluble in toluene was separated off by filtration, dried and weighed. The gel content was defined as the quotient of the weight of the dried gel and the weight of the original latex film (before swelling with toluene) and was stated in percent.

Gel Permeation Chromatography (GPC):

With the aid of GPC, it was possible to determine the molar mass of polymers. For this purpose, it was necessary for the polymers to dissolve completely in the solvent used. In the present case, tetrahydrofuran was used as the solvent. The flow rate was 1 ml/min. Polystyrene standards were used for calibrating the columns.

Preparation of Coating Slip Formulations for Coating Paper and Cardboard:

11 parts by weight of each of the latices were used in a formulation of 30 parts by weight of clay and 70 parts by weight of carbonate. The pH of the formulation is 8.5 and the solids content was 65%. Each formulation was applied to a wood-free base paper having a weight of 67 g/m² in a coat weight of 12 g/m².

Paper Gloss:

The paper gloss was determined using a gloss measuring instrument of the type “LGDL-03 Labor” from Lehmann. The measuring head had a 75° geometry (Tappi standard). The paper to be measured rested flat on a smooth surface. Three sheets were chosen for each test, five individual measurements were carried out on each sheet. The stated value for the paper gloss is the mean value of the individual measurements.

Print Gloss:

The coated paper was printed on a multipurpose proof press from Prüfbau with the ink “Reflecta-schwarz 49 N 8000” from Huber. The impression pressure of the rollers is 500 N and the printing speed was 0.5 m/s. The measurement of the gloss on the printed paper was carried out analogously to the paper gloss measurement described above.

Dry Pick Resistance:

The dry pick resistance was determined using a multipurpose proof press from Prüfbau. At least three test strips were printed for each test with the ink 408004 from Huber at a speed of 2 m/s (increasing). The stated measured value for the dry pick resistance is the mean value of the individual measurements.

Offset Test:

The offset test was performed using a multipurpose proof press from Prüfbau. For each test, a test strip was printed with the ink 520068 from Huber at a speed of 0.5 m/s. The same strip was printed again after 10 s with the same roller. The process was repeated until the paper had picks. The number of printing processes until the occurrence of picks gave the measured value for the offset test.

Printing Ink Setting:

The speed of the printing ink setting was determined using a multipurpose proof press from Prüfbau. For each test, a test strip was printed with the ink 520068 from Huber at a speed of 0.5 m/s. The strip was covered with a counterstrip immediately after the printing process and was passed through the printing unit after 15 s over a distance of 5 cm. After further time intervals (e.g. 30 s, 60 s, 180 s), the print medium was conveyed a further 5 cm in each case. In this way, ink was transferred from the printed strip to the counterstrip. The ink density was evaluated using a densitometer of the type “RD 918” from Macbeth. The ink density on the counterstrip as a function of the time interval was a measure of the speed of the printing ink setting.

Preparation of the Model Latices:

For investigating the regulator efficiency of the peroxides described, model latices were synthesized (based on styrene and acrylic acid). These were prepared by emulsion polymerization of a monomer composition comprising 96% by weight of styrene and 4% by weight of acrylic acid in the presence of 1% by weight of emulsifier (sodium dodecylbenzenesulfonate) and varying amounts and types of peroxide chain transfer agents. This polymerization was carried out as a seeded free radical emulsion polymerization with a particle size of from 150 to 160 nanometers (nm) at a temperature of from 75° C. to 95° C. The molar mass of the polymers were investigated with the aid of gel permeation chromatography (GPC).

Preparation of the Latices:

The polymer latices described were prepared by emulsion polymerization of a monomer composition comprising 56% by weight of styrene, 40% by weight of butadiene and 4% by weight of acrylic acid in the presence of 0.6% by weight of emulsifier (sodium dodecylbenzenesulfonate) and varying amounts and types of peroxide chain transfer agents. This polymerization was carried out as a seeded free radical emulsion polymerization with a particle size of 150 to 160 nanometers at a temperature of from 75° C. to 95° C.

### EXAMPLES

TABLE 1
Properties of the model latices

| | | Amount of | | | | |
|---|---|---|---|---|---|---|
| | | regulator | Particle size | Mₙ | M_{w} | |
| Latex | Regulator types | (pph) | (nm) | (g/mol) | (g/mol) | M_{w}/Mₙ |
| M1 | — | — | 155 | 112400 | 689600 | 6.14 |
| M2 | tert-Butyl hydroperoxide | 1.0 | 155 | 46500 | 194400 | 4.18 |
| M3 | Cumyl hydroperoxide | 1.0 | 155 | 30700 | 88300 | 2.88 |

In the present example, the peroxides used proved to be efficient as regulators at the lower molar mass and at the lower polydispersity of the latices M2 and M3 in comparison with latex M1.

TABLE 2
Latex properties

| | | Amount of | Polym. | | Glass | Gel |
|---|---|---|---|---|---|---|
| | | regulator | temp. | Particle | transition | content |
| Latex | Regulator type | (pph) | (° C.) | size (nm) | temp. (° C.) | (%) |
| Ref.* | t-DDM | 1.1 | 85 | 165 | 18 | 74 |
| 1 | — | — | 85 | 155 | 14 | 98 |
| 2 | t-Butyl hydroperoxide | 0.5 | 75 | 155 | 14 | 88 |
| 3 | t-Butyl hydroperoxide | 0.5 | 80 | 155 | 14 | 90 |
| 4 | t-Butyl hydroperoxide | 1.0 | 75 | 155 | 14 | 79 |
| 5 | t-Butyl hydroperoxide | 1.0 | 80 | 150 | 14 | 83 |
| 6 | Cumyl hydroperoxide | 1.0 | 85 | 160 | 14 | 93 |
| 7 | Cumyl hydroperoxide | 1.5 | 85 | 155 | 14 | 83 |
| 8 | Cumyl hydroperoxide | 2.0 | 85 | 160 | 14 | 72 |
| 9 | Di-tert-butyl peroxide | 1.0 | 95 | 160 | 14 | 98 |
| 10 | t-Butyl | 1.0 | 85 | 160 | 14 | 96 |
| | peroxybenzoate | | | | | |
| 11 | t-Butyl peroxy-3,5,5- | 1.0 | 85 | 155 | 14 | 96 |
| | trimethylhexanoate | | | | | |

*Standard XSBR latex with wide application range

TABLE 3
Properties of the coated paper

| | | | | | Printing ink |
|---|---|---|---|---|---|
| | | | | Offset test | setting (color |
| | | | Pick | (number of | density of |
| | Paper | Print | resistance | printing | counterstrip |
| Latex | gloss (%) | gloss (%) | (cm/s) | processes) | ater 15 s) |
| Ref.* | 67 | 73 | 84 | 6 | 0.74 |
| 1 | 67 | 60 | 40 | 2 | 0.40 |
| 2 | 63 | 69 | 93 | 4 | 0.56 |
| 3 | 64 | 69 | 80 | 4 | 0.57 |
| 4 | 67 | 71 | 97 | 3 | 0.61 |
| 5 | 66 | 72 | 88 | 4 | 0.66 |
| 6 | 65 | 71 | 69 | 3 | 0.59 |
| 7 | 65 | 75 | 72 | 4 | 0.65 |
| 8 | 66 | 78 | 85 | 5 | 0.78 |
| 9 | 66 | 60 | 51 | 3 | 0.39 |

*Standard XSBR latex with wide application range

German patent application 102 30 793.8, filed Jul. 8, 2002, and all references and patent mentioned in this application are incorporated herein by reference.

Numerous modifications and variations on the present invention are possible in light of the above teachings. It is therefore to be understood that within the scope of the appended claims, the invention may be practiced otherwise than as specifically described herein.

1. A polymer latex, prepared using a sulfur-free and halogen-free chain transfer agent and comprising, in polymerized form:
a) from 10% to 80% by weight of one or more monovinylaromatic monomers;
b) from 0% to 70% by weight of one or more conjugated diene monomers;
c) from 0% to 70% by weight of one or more acrylate monomers; and
d) a remainder of one or more other copolymerizable comonomers, with the condition that a sum of the percentages by weight of components b) and c) is greater than zero,
wherein said chain transfer agent is at least one peroxide selected from the group consisting of compounds of formulae A) to F)
A) hydroperoxides of the formula
R—O—O—H
wherein R is H or one of the following radicals:
linear or branched C₁-C₁₆ alkyl,
linear or branched C₁-C₁₆ alkyl in combination with C₁-C₁₈ aryl, or C₁-C₁₈ aryl;
B) peroxides of the formula
R₁—O—O—R₂
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl;
C) peroxides of the formula 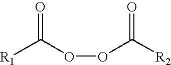
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl;
D) peroxocarboxylic acids of the formula 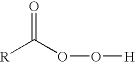
wherein R is H or one of the following radicals:
linear or branched C₁-C₁₆ alkyl,
linear or branched C₁-C₁₆ alkyl in combination with C₁-C₁₈ aryl, or C₁-C₁₈ aryl;
E) peroxocarboxylic esters of the formula 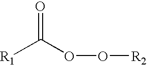
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl; and
F) peroxodicarbonates of the formula 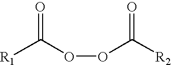
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl; and
wherein said polymer latex has a glass transition temperature of from −30° C. to 70° C.

2. The polymer latex as claimed in claim 1, wherein said chain transfer agent is at least one peroxide selected from the group consisting of said hydroperoxides.

3. The polymer latex as claimed in claim 2, wherein said peroxide is selected from the group consisting of tert-butyl hydroperoxide, cumyl hydroperoxide and mixtures thereof.

4. The polymer latex as claimed in claim 1, wherein said peroxide is selected from the group consisting of di-tert-butyl peroxide, tert-butyl peroxybenzoate and tert-butyl peroxy-3,5,5-trimethylhexanoate.

5. The polymer latex as claimed in claim 1, wherein component a) is styrene, component b) is butadiene and component c) is an ethylenically unsaturated carboxylic acid.

6. The polymer latex as claimed in claim 1, comprising in polymerized form: styrene, butadiene, acrylic acid.

7. The polymer latex as claimed in claim 1, comprising 1 to 20% by weight of component c) which is a nitrile monomer alone or a mixture of nitrile monomers.

8. The polymer latex as claimed in claim 7, wherein said nitrile monomer is acrylonitrile.

9. The polymer latex as claimed in claim 1, comprising in polymerized form: styrene, butadiene, acrylonitrile, acrylic acid.

10. A composition for the coating of paper and/or cardboard, comprising:
the polymer latex according to claim 1.

11. The composition as claimed in claim 10, wherein said peroxide is selected from the group consisting of said hydroperoxides.

12. The composition as claimed in claim 10, wherein said peroxide is selected from the group consisting of tert-butyl hydroperoxide, cumyl hydroperoxide and mixtures thereof.

13. The composition as claimed in claim 10, wherein said peroxide is selected from the group consisting of di-tert-butyl peroxide, tert-butyl peroxybenzoate and tert-butyl peroxy-3,5,5-trimethylhexanoate.

14. A process for the preparation of a polymer latex, comprising:
reacting
a) from 10% to 80% by weight of one or more monovinylaromatic monomers;
b) from 0% to 70% by weight of one or more conjugated diene monomers;
c) from 0% to 70% by weight of one or more acrylate monomers; and
d) a remainder of one or more other copolymerizable comonomers, with the condition that a sum of the percentages by weight of components b) and c) is greater than zero, in the presence of a sulfur-free and halogen-free chain transfer agent, to obtain a polymer latex having a glass transition temperature of from −30 to 70° C.;
wherein said chain transfer agent is at least one peroxide selected from the group consisting of compounds of formulae A) to F)
A) hydroperoxides of the formula
R—O—O—H
wherein R is H or one of the following radicals:
linear or branched C₁-C₁₆ alkyl,
linear or branched C₁-C₁₆ alkyl in combination with C₁-C₁₈ aryl, or C₁-C₁₈ aryl;
B) peroxides of the formula
R₁—O—O—R₂
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl;
C) peroxides of the formula 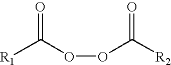
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl;
D) peroxocarboxylic acids of the formula 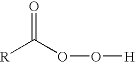
wherein R is H or one of the following radicals:
linear or branched C₁-C₁₆ alkyl,
linear or branched C₁-C₁₆ alkyl in combination with C₁-C₁₈ aryl, or C₁-C₁₈ aryl;
E) peroxocarboxylic esters of the formula 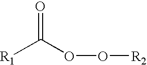
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl; and
F) peroxodicarbonates of the formula 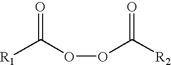
wherein R₁ and R₂ are identical or different and are one of the following radicals:
linear or branched C₁-C₁₆ alkyl,
linear or branched C₁-C₁₆ alkyl in combination with C₁-C₁₈ aryl, or C₁-C₁₈ aryl.

15. The process according to claim 14, wherein said reacting proceeds at a temperature of from 0 to 130° C. in the presence of one or more emulsifiers and one or more initiators.

16. The process according to claim 14, wherein said chain transfer agent is at least one peroxide selected from the group consisting of said hydroperoxides.

17. The process according to claim 16, wherein said peroxide is selected from the group consisting of tert-butyl hydroperoxide, cumyl hydroperoxide and mixtures thereof.

18. The process according to claim 14, wherein said peroxide is selected from the group consisting of di-tert-butyl peroxide, tert-butyl peroxybenzoate and tert-butyl peroxy-3,5,5-trimethylhexanoate.

19. The process according to claim 14, wherein component a) is styrene, component b) is butadiene and component c) is an ethylenically unsaturated carboxylic acid.

20. The process according to claim 14, wherein said peroxide is present in an amount of from 0.1 to 10% by weight.
